(19) United States
(12) Patent Application Publication
(10) Pub. No.: US 2015/0100813 A1
(43) Pub. Date: Apr. 9, 2015

(54) METHOD AND DEVICE FOR PROCESSING IMAGES TO SAVE POWER

(71) Applicant: Samsung Electronics Co., Ltd., Suwon-si (KR)

(72) Inventors: Sun-young HAN, Suwon-si (KR); Sang-ho KIM, Suwon-si (KR); Seok-min OH, Seongnam-si (KR); Woo-hyoung LEE, Yongin-si (KR)

(21) Appl. No.: 14/501,731

(22) Filed: Sep. 30, 2014

(30) Foreign Application Priority Data
Oct. 4, 2013 (KR) 10-2013-0118732

(51) Int. Cl. G09G 5/02; G06F 1/28

(52) U.S. Cl. CPC G09G 5/02; G06F 1/28
USPC 713/340

(57) ABSTRACT

A method and a device for processing images to save power are provided. A method by which a device processes images displayed on a screen includes determining a battery level of the device, comparing the battery level with a plurality of set threshold ranges, and changing a background image and an icon image displayed on the screen of the device based on a comparison result.

### CROSS-REFERENCE TO RELATED APPLICATION(S)

This application claims the benefit under 35 U.S.C. §119(a) of a Korean patent application filed on Oct. 4, 2013 in the Korean Intellectual Property Office and assigned Serial number 10-2013-0118732, the entire disclosure of which is hereby incorporated by reference.

### TECHNICAL FIELD

The present disclosure relates to a method and a device for processing images to save power. More particularly, the present disclosure relates to a method and a device for changing a background image and an icon image according to a battery level of the device.

### BACKGROUND

Recently, due to the wide popularization of portable devices, many people have used at least one portable device. In addition, the technology for manufacturing slim and light portable devices has been steadily developed to improve the portability of portable devices. Furthermore, since users prefer a device having a display of a wide area, power efficiency of portable devices is low, and thus the users are inconvenienced such that it is difficult to use a portable device having a limited capacity of battery for a long time.

A method of reducing the brightness of a display of a portable device in a hardware manner in order to reduce power consumption of the display has been used. However, the method inconveniences the users since the visibility of a screen is significantly lowered when the surroundings are bright.

Therefore, a need exists for a method and a device for saving power of a portable device by changing an image displayed on a screen of the portable device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and a device for processing images to save power, by which power consumption of the device can be saved by changing images displayed on a screen of the device.

Additional aspects will be set forth in part in the description which follows and, in part, will be apparent from the description, or may be learned by practice of the presented embodiments.

In accordance with an aspect of the present disclosure, a method by which a device processes images displayed on a screen is provided. The method includes determining a battery level of the device, comparing the battery level with a plurality of set threshold ranges, and changing a background image and an icon image displayed on the screen of the device based on a comparison result.

In accordance with another aspect of the present disclosure, a device for processing images displayed on a screen is provided. The device includes a display unit configured to display a background image and an icon image, and a control unit configured to determine a battery level of the device, to compare the determined battery level with a plurality of set threshold ranges, and to change the displayed background image and icon image based on a comparison result.

According to another embodiment of the present disclosure, a non-transitory computer-readable storage medium having stored therein program instructions, which when executed by a computer, perform the method.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B illustrate a device in which a background image and an icon image displayed on a screen thereof are changed for power saving according to an embodiment of the present disclosure;

FIG. 2 is a flowchart of a method by which a device changes a background image and an icon image on a screen according to a battery level according to an embodiment of the present disclosure;

FIG. 3 is a flowchart of a method by which a device changes a background image, an icon image, and a widget image on a screen according to a battery level according to an embodiment of the present disclosure;

FIG. 4 is a flowchart of a method by which a device changes a background image, an icon image, and a widget image on a screen by comparing a battery level with a plurality of threshold ranges according to an embodiment of the present disclosure;

FIGS. 5A and 5B illustrate a change of a background image and a widget image on a screen of a device when a battery level of the device is within a first threshold range according to an embodiment of the present disclosure;

FIGS. 6A and 6B illustrate a change of a background image, a widget image, and an icon image on a screen of a device when a battery level of the device is within a second or third threshold range according to an embodiment of the present disclosure;

FIG. 7 is a flowchart of a method by which a device changes a background image and an icon image on a screen according to a power saving level set by a user according to an embodiment of the present disclosure;

FIG. 8 is a flowchart of a method by which a device changes a background image, an icon image, and a widget image on a screen according to a power saving level set by a user according to an embodiment of the present disclosure;

FIG. 9 is a flowchart of a method by which a device changes a background image, an icon image, and a widget image on a screen according to a power saving level set by a user according to an embodiment of the present disclosure;

FIG. 10 illustrates a power saving level setting menu displayed on a setting screen of a device according to an embodiment of the present disclosure;

FIG. 11 illustrates a power saving level setting menu displayed in a widget format on a screen of a device according to an embodiment of the present disclosure; and

FIGS. 12 and 13 are block diagrams for describing a configuration of a device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

In embodiments of the present disclosure, when a certain part is “connected” to another part, this indicates that the part may be “directly connected” to another part or may be “electrically connected” to another part by interposing a third part therebetween. In addition, when a certain part “includes” a certain component, this indicates that the part may further include another component instead of excluding another component unless there is different disclosure.

In addition, in embodiments of the present disclosure, a battery level of a device indicates a value representing a remaining capacity of a battery of the device. The battery level may indicate, for example, a remaining percentage (%) of a total capacity of the battery but is not limited thereto.

In addition, in embodiments of the present disclosure, a power saving level is a value set to manage power saving, and the higher the power saving level, the more power consumption of a device may be reduced.

As used herein, the term “and/or” includes any and all combinations of one or more of the associated listed items. Expressions, such as “at least one of,” when preceding a list of elements, modify the entire list of elements and do not modify the individual elements of the list.

Hereinafter, various embodiments of the present disclosure will be described more fully with reference to the accompanying drawings.

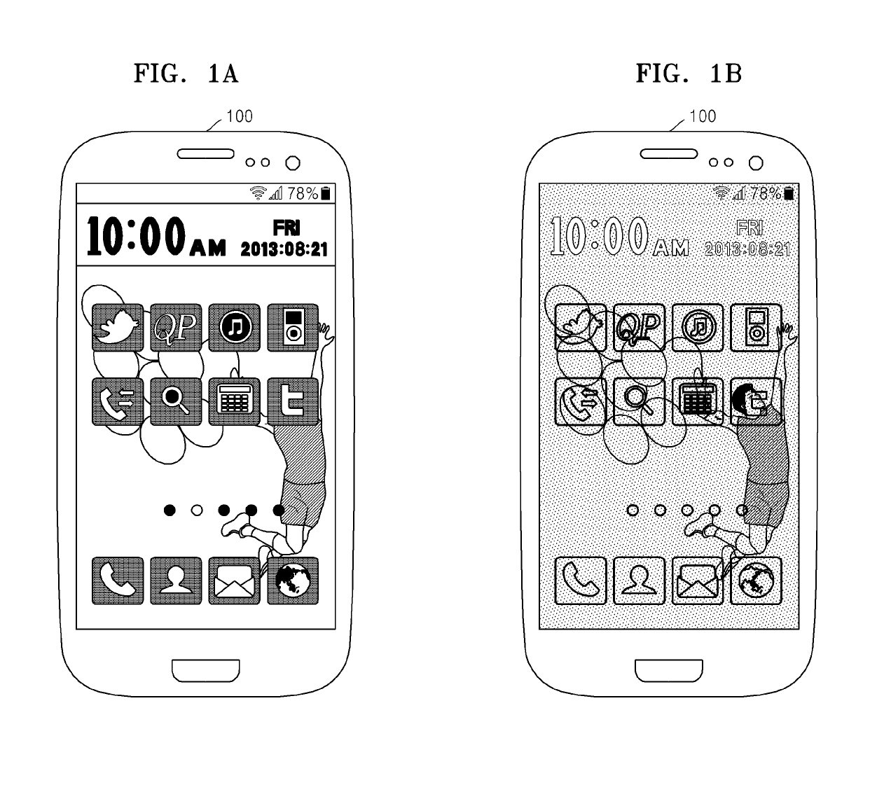

FIGS. 1A and 1B illustrate a device in which a background image and an icon image displayed on a screen thereof are changed for power saving according to an embodiment of the present disclosure.

Referring to FIGS. 1A and 1B, a background image, a widget image, and an icon image may be displayed on the screen of a device 100. When a battery level of the device 100 is lowered and is within a set threshold range, the device 100 may change the background image, the widget image, and the icon image. Power of the device 100 may be saved by displaying the changed background image, the changed widget image, and the changed icon image.

When a power saving level of the device 100 is set to a set level by an input of a user, the device 100 may change the background image, the widget image, and the icon image. Power of the device 100 may be saved by displaying the changed background image, the changed widget image, and the changed icon image.

The device 100 may be a smartphone, a smart TV, a cellular phone, a Personal Digital Assistant (PDA), a laptop computer, a media player, a micro server, a Global Positioning System (GPS) device, an e-book terminal, a digital broadcasting terminal, a navigation device, a kiosk, a Motion Pictures Expert Group (MPEG-1 or MPEG-2) Audio Layer 3 (MP3) player, a digital camera, or another mobile or non-mobile computing device but is not limited thereto. The device 100 may include various devices capable of receiving a touch input, such as an electronic whiteboard, a touch table, and the like.

The background image may be a background image displayed on a home screen of the device 100, and the icon image may include icons for executing applications installed in the device 100, but the background image and the icon image are not limited thereto. For example, the background image may be an image used as a background on an execution screen of an application, and the icon image may include buttons for executing certain functions of an application and titles indicating certain information on an execution screen of an application.

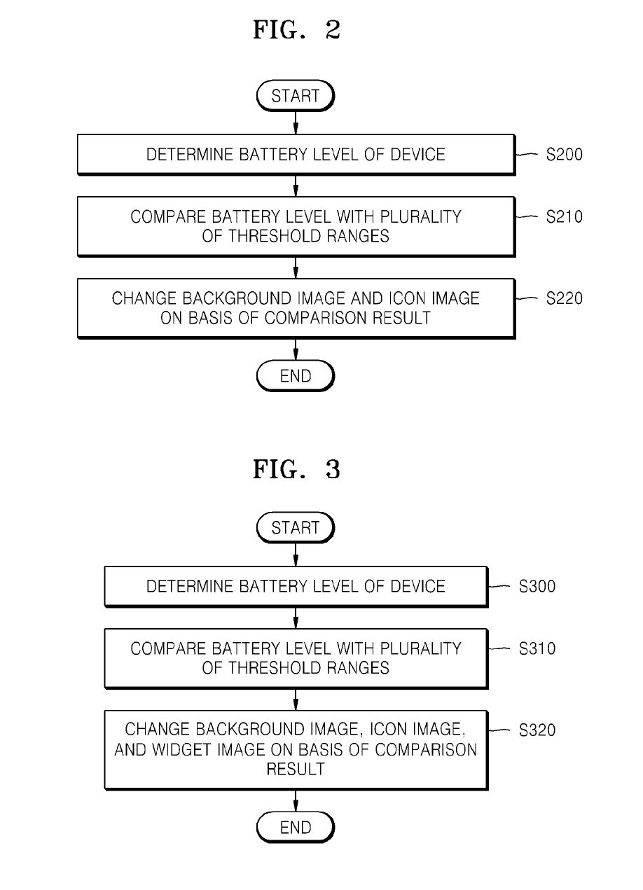

FIG. 2 is a flowchart of a method by which a device changes a background image and an icon image on a screen according to a battery level according to an embodiment of the present disclosure.

Referring to FIG. 2, in operation S200, the device 100 determines a battery level of the device 100. For example, the device 100 may measure a remaining capacity of a battery of the device 100 as a percentage (%) of a total capacity of the battery.

In operation S210, the device 100 compares the battery level of the device 100 with a plurality of threshold ranges. The threshold ranges may indicate ranges of a remaining capacity of the battery and may be set by a user or a manufacturer. The plurality of threshold ranges may include, for example, a first threshold range, a second threshold range, and a third threshold range. The first threshold range may be, for example, a range of 30%-20% of the total capacity of the battery, the second threshold range may be, for example, a range of 20%-10% of the total capacity of the battery, and the third threshold range may be, for example, a range of 10%-0% of the total capacity of the battery. The device 100 may determine whether the battery level is within which threshold range by comparing the battery level with the plurality of threshold ranges.

In operation S220, the device 100 changes the background image and the icon image based on the comparison result in operation S210. The device 100 may change the background image and the icon image by using software installed in the device 100 and may selectively display the changed background image and the changed icon image on the screen of the device 100.

For example, when the battery level of the device 100 is within the first threshold range (for example, the range of 30%-20% of the total capacity of the battery), the device 100 may change a brightness of the background image and display the changed background image on the screen. In another example, when the battery level of the device 100 is within the second threshold range (for example, the range of 20%-10% of the total capacity of the battery), the device 100 may change the icon image to an image of a line-drawing style and display the changed icon image on the screen. An image of the line-drawing style may be an image in which a main portion of an original image is represented as a line. In another example, when the battery level of the device 100 is within the third threshold range (for example, the range of 10%-0% of the total capacity of the battery), the device 100 may change the background image to a black image and change a color of the icon image changed to the line-drawing style.

In this case, the device 100 may change, to a low-power color, the color of the icon image changed to the line-drawing style. The low-power color indicates a color needed to be displayed on the screen in order to reduce power consumption of the device 100, for example, a color causing power consumption that is a set value or less. The low-power color may be set based on experimental data regarding colors displayed on the screen of the device 100 and power consumption of the device 100. For example, in order to reduce power consumption of an Organic Light-Emitting Diode (OLED) display, the low-power color may be set to a green-based color. The low-power color may be set differently according to a type of a display forming the screen of the device 100 and device characteristics of the device 100.

The device 100 may adjust brightness of the background image by measuring an average brightness value of the background image and adjusting a gamma value of the background image based on the measured average brightness value. The device 100 may measure the average brightness value of the background image and adjust the gamma value of the background image by, for example, controlling an Operating System (OS) of the device 100.

The device 100 may display and change the background image and the icon image through layers. For example, the device 100 may display the background image through a first layer and display the icon image through a second layer. The device 100 may change a brightness of the background image included in the first layer according to a change in the battery level. The device 100 may change the icon image included in the second layer to the line-drawing style and change a color of the icon image changed to the line-drawing style.

In this case, the first layer may be a less significant layer, and the second layer may be a significant layer. Various types of Graphical User Interface (GUI) elements may be matched with the first or second layer. For example, the device 100 may set the background image on the home screen so as to be displayed through the first layer and set the icon image for executing applications so as to be displayed through the second layer. In another example, the device 100 may set a background image on an execution screen of an application so as to be displayed through the first layer and set buttons and titles included in the execution screen of the application so as to be displayed through the second layer.

The device 100 may previously generate and store a layer including the background image of which the brightness has been changed and a layer including the icon image changed to the line-drawing style. In this case, the brightness of the background image may be changed variously according to the battery level, and a plurality of layers including background images of which the brightness has been changed may be previously stored in the device 100. A layer including the icon image changed to the line-drawing style according to the battery level may be previously stored in the device 100. In addition, a layer including the icon image which has been changed to the line-drawing style and of which a color has been changed according to the battery level may be previously stored in the device 100. Accordingly, the device 100 may determine the battery level, call at least one layer corresponding to the determined battery level, and display the called at least one layer.

FIG. 3 is a flowchart of a method by which a device changes a background image, an icon image, and a widget image on a screen according to a battery level according to an embodiment of the present disclosure.

Referring to FIG. 3, in operation S300, the device 100 determines a battery level of the device 100. For example, the device 100 may measure a remaining capacity of a battery of the device 100 as a percentage (%) of a total capacity of the battery.

In operation S310, the device 100 compares the battery level of the device 100 with a plurality of threshold ranges. The threshold ranges may indicate ranges of a remaining capacity of the battery and may be set by a user or a manufacturer. The plurality of threshold ranges may include, for example, the first threshold range, the second threshold range, and the third threshold range. The first threshold range may be, for example, a range of 30%-20% of the total capacity of the battery, the second threshold range may be, for example, a range of 20%-10% of the total capacity of the battery, and the third threshold range may be, for example, a range of 10%-0% of the total capacity of the battery. The device 100 may determine whether the battery level is within which threshold range by comparing the battery level with the plurality of threshold ranges.

In operation S320, the device 100 changes the background image, the icon image, and the widget image based on the comparison result in operation S310. The device 100 may change the background image, the icon image, and the widget image by using software installed in the device 100 and may selectively display the changed background image, the changed icon image, and the changed widget image on the screen of the device 100.

For example, when the battery level of the device 100 is within the first threshold range (for example, the range of 30%-20% of the total capacity of the battery), the device 100 may change a brightness of the background image and brightness of the widget image. The device 100 may display the changed background image and the changed widget image on the screen.

In another example, when the battery level of the device 100 is within the second threshold range (for example, the range of 20%-10% of the total capacity of the battery), the device 100 may change the icon image and the widget image to images of the line-drawing style and display the changed icon image and the changed widget image on the screen.

In another example, when the battery level of the device 100 is within the third threshold range (for example, the range of 10%-0% of the total capacity of the battery), the device 100 may change the background image to a black image and change a color of the icon image changed to the line-drawing style and the widget image changed to the line-drawing style.

In this case, the device 100 may change, to a low-power color, the color of the icon image changed to the line-drawing style and the color of the widget image changed to the line-drawing style.

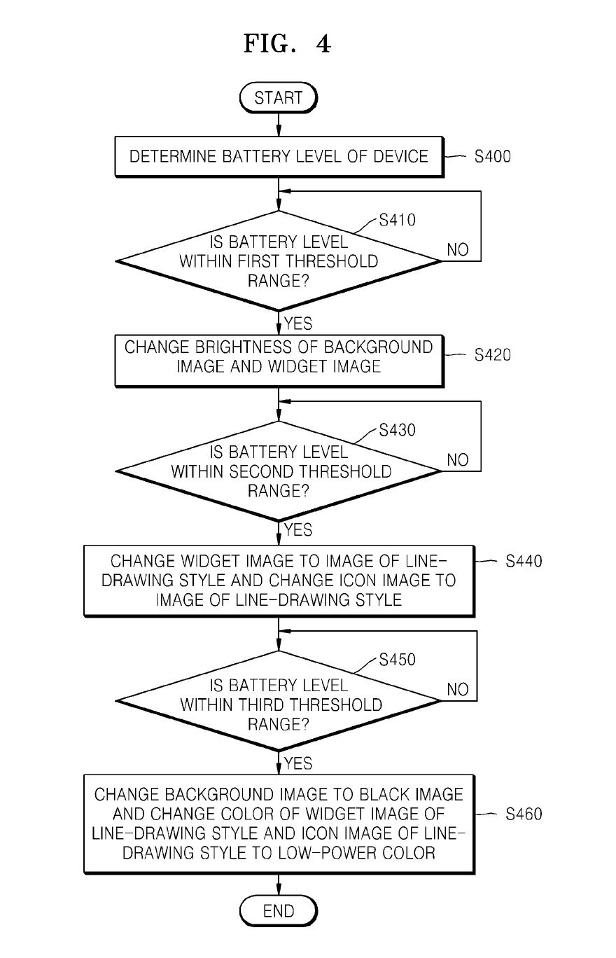

FIG. 4 is a flowchart of a method by which a device changes a background image, an icon image, and a widget image on a screen by comparing a battery level with a plurality of threshold ranges according to an embodiment of the present disclosure.

Referring to FIG. 4, in operation S400, the device 100 determines a battery level of the device 100. For example, the device 100 may measure a remaining capacity of a battery of the device 100 as a percentage (%) of a total capacity of the battery.

In operation S410, the device 100 determines whether the battery level is within the first threshold range. The first threshold range may be a range less than a first threshold value and greater than a second threshold value, for example, a range of 30%-20% of the total capacity of the battery. The device 100 may determine whether the battery level is within the first threshold range by comparing the battery level with the first threshold value and the second threshold value.

If the battery level of the device 100 is within the first threshold range as the determination result in operation S410, the device 100 changes brightness of the background image and the widget image in operation S420. The device 100 may change the brightness of the background image and the widget image by using software installed in the device 100. For example, the device 100 may change the brightness of the background image and the widget image by applying an image filter to the background image and the widget image. The device 100 may display the background image and the widget image of which the brightness has been changed, on the screen of the device 100.

In addition, in operation S420, the device 100 may maintain a graphic style of the background image, a graphic style of the widget image, an image effect applied to the background image, an image effect applied to the widget image, and a font style of widget image without change. In addition, in operation S420, the device 100 may not change the icon image. The device 100 may maintain a graphic style of the icon image, an image effect applied to the icon image, and a font style of the icon image without change.

In operation S430, the device 100 determines whether the battery level is within the second threshold range. The second threshold range may be a range less than the second threshold value and greater than a third threshold value, for example, a range of 20%-10% of the total capacity of the battery. The device 100 may determine whether the battery level is within the second threshold range by comparing the battery level with the second threshold value and the third threshold value.

If the battery level of the device 100 is within the second threshold range as the determination result in operation S430, the device 100 changes the widget image to an image of the line-drawing style and changes the icon image to an image of the line-drawing style in operation S440. The device 100 may change the widget image and the icon image to images of the line-drawing style by using software installed in the device 100. The device 100 may change the widget image and the icon image to images of the line-drawing style by using, for example, an edge detection technique. The device 100 may display the widget image of the line-drawing style and the icon image of the line-drawing style on the screen of the device 100. The widget image of the line-drawing style and the icon image of the line-drawing style may exhibit a white color but are not limited thereto. The widget image of the line-drawing style and the icon image of the line-drawing style may be previously generated and stored in a memory of the device 100.

In addition, in operation S440, the device 100 may remove the image effect applied to the background image, the image effect applied to the widget image, the image effect applied to the icon image. In addition, in operation S440, the device 100 may maintain the font style of the icon image and the font style of the widget image without change. However, one or more embodiments of the present disclosure are not limited thereto.

In operation S450, the device 100 determines whether the battery level is within the third threshold range. The third threshold range may be a range less than the third threshold value and greater than 0, for example, a range of 10%-0% of the total capacity of the battery. The device 100 may determine whether the battery level is within the third threshold range by comparing the battery level with the third threshold value and 0.

If the battery level of the device 100 is within the third threshold range as the determination result in operation S450, the device 100 changes the background image to a black image and changes a color of the widget image of the line-drawing style and the icon image of the line-drawing style to a low-power color in operation S460. The device 100 may display the black image, the widget image of the line-drawing style of which the color has been changed, and the icon image of the line-drawing style of which the color has been changed, on the screen of the device 100.

The low-power color may be set based on experimental data regarding colors displayed on the screen of the device 100 and power consumption of the device 100. For example, in order to reduce power consumption of an OLED display, the low-power color may be set to a green-based color. The low-power color may be set differently according to a type of a display forming the screen of the device 100 and device characteristics of the device 100.

In addition, in operation S460, the device 100 may enable light-emitting elements corresponding to the icon image changed to the line-drawing style among light-emitting elements for displaying images on the screen of the device 100. In addition, the device 100 may disable light-emitting elements (the other light-emitting elements which do not correspond to the icon image changed to the line-drawing style) corresponding to the black image. However, one or more embodiments of the present disclosure are not limited thereto.

In addition, in operation S460, the device 100 may change the font style of the icon image and the font style of the widget image. For example, the device 100 may make a thickness of a text in the icon image and a thickness of a text in the widget image thin. However, one or more embodiments of the present disclosure are not limited thereto.

It has been described with reference to FIGS. 2 to 4 that the brightness of the background image and the widget image is discontinuously changed according to a threshold range. However, one or more embodiments of the present disclosure are not limited thereto. The brightness of the background image and the widget image may be continuously changed according to the battery level. For example, when the battery level of the device 100 is gradually lowered, the device 100 may change the brightness of the background image and the widget image to be gradually dark.

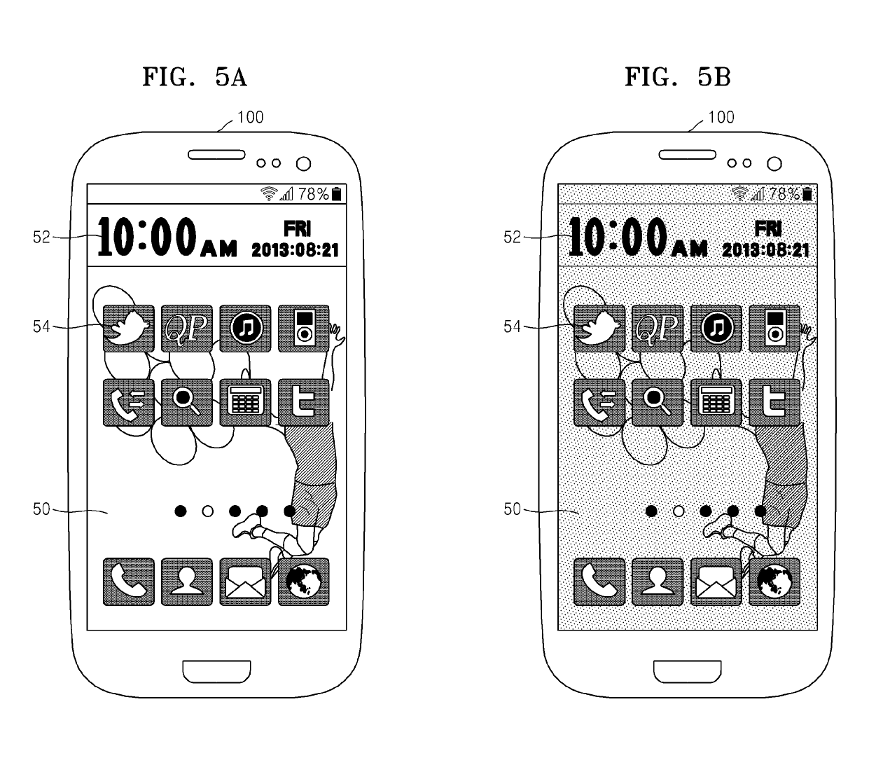

FIGS. 5A and 5B illustrate a change of a background image and a widget image on a screen of a device when a battery level of the device is within a first threshold range according to an embodiment of the present disclosure.

Referring to FIG. 5A, when the battery level of the device 100 is greater than the first threshold value, the device 100 may display a background image 50, a widget image 52, and an icon image 54 according to default values thereof. For example, the background image 50, the widget image 52, and the icon image 54 may be realized as a full color. In addition, for example, set image effects may be respectively applied to the background image 50, the widget image 52, and the icon image 54. In addition, for example, graphic styles of the background image 50, the widget image 52, and the icon image 54 may be respectively maintained as default styles. In addition, font styles of the background image 50, the widget image 52, and the icon image 54 may be respectively maintained as default styles.

Referring to FIG. 5B, when the battery level of the device 100 is within the first threshold range, brightness of the background image 50 and the widget image 52 may be changed. For example, the device 100 may change the brightness of the background image 50 and the widget image 52 by applying an image filter to the background image 50 and the widget image 52. The device 100 may display the background image 50 and the widget image 52 of which the brightness has been changed, on the screen of the device 100. The device 100 may not change the icon image 54.

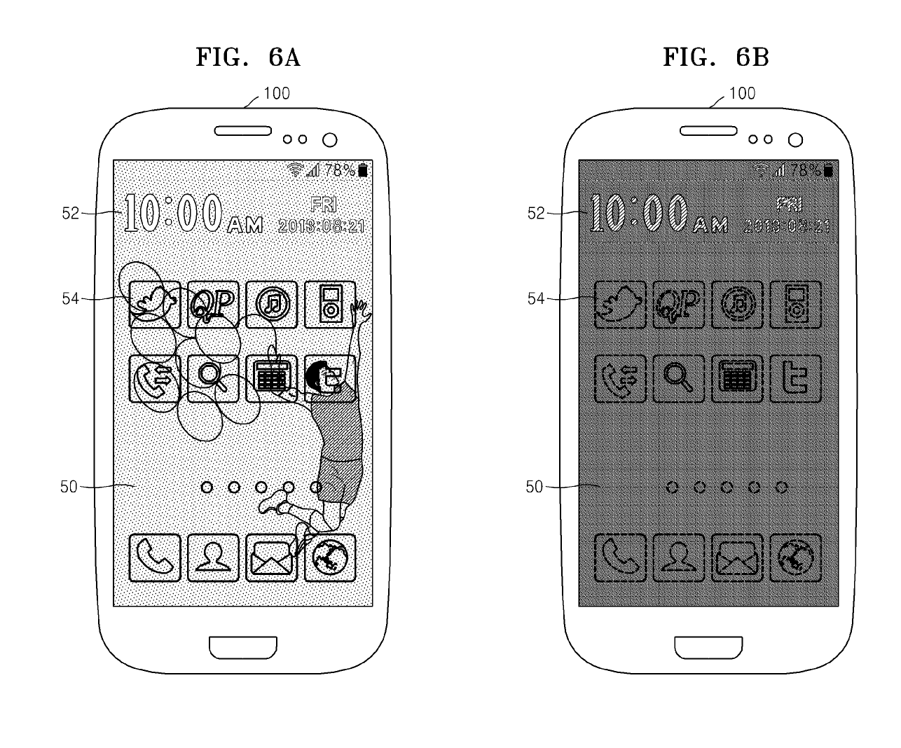

FIGS. 6A and 6B illustrate a change of a background image, a widget image, and an icon image on a screen of a device when a battery level of the device is within a second or third threshold range according to an embodiment of the present disclosure.

Referring to FIG. 6A, when the battery level of the device 100 is within the second threshold range, the device 100 may change a style of the widget image 52 to the line-drawing style and change a style of the icon image 54 to the line-drawing style. In this case, the widget image 52 and the icon image 54 of which the style has been changed to the line-drawing style may be displayed with a white color.

Referring to FIG. 6B, when the battery level of the device 100 is within the third threshold range, the device 100 may change the background image 50 to a black color and change a color of the widget image 52 and the icon image 54 to a green color.

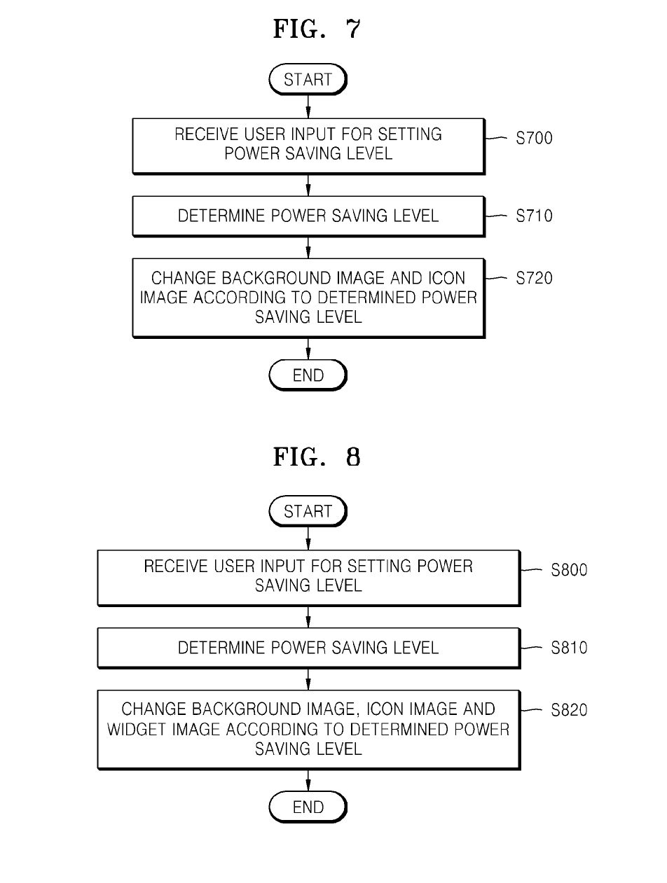

FIG. 7 is a flowchart of a method by which a device changes a background image and an icon image on a screen according to a power saving level set by a user according to an embodiment of the present disclosure.

Referring to FIG. 7, in operation S700, the device 100 receives a user input for setting the power saving level. The device 100 may display a user interface for setting the power saving level, on the screen of the device 100 and may receive a user input through the displayed user interface. For example, the user interface for setting the power saving level may be included in a setting screen of the device 100. In another example, the user interface for setting the power saving level may be included in a certain widget. The power saving level may include, for example, a first power saving level, a second power saving level, and a third power saving level but is not limited thereto.

In operation S710, the device 100 determines the power saving level based on the user input. The device 100 may determine the power saving level according to the user input received in operation S700.

In operation S720, the device 100 changes the background image and the icon image according to the determined power saving level. The device 100 may change the background image and the icon image by using software installed in the device 100 and may selectively display the changed background image and the changed icon image on the screen of the device 100.

For example, when the power saving level of the device 100 is the first power saving level, the device 100 may change a brightness of the background image and display the changed background image on the screen. In another example, when the power saving level of the device 100 is the second power saving level, the device 100 may change the icon image to an image of the line-drawing style and display the changed icon image on the screen. The image of the line-drawing style may be an image in which a main portion of an original image is represented as a line. In another example, when the power saving level of the device 100 is the third power saving level, the device 100 may change the background image to a black image and change a color of the icon image changed to the line-drawing style.

In this case, the device 100 may change the color of the icon image changed to the line-drawing style to a low-power color. The low-power color may be set based on experimental data regarding colors displayed on the screen of the device 100 and power consumption of the device 100. For example, in order to reduce power consumption of an OLED display, the low-power color may be set to a green-based color. The low-power color may be set differently according to a type of a display forming the screen of the device 100 and device characteristics of the device 100.

The device 100 may adjust brightness of the background image by measuring an average brightness value of the background image and adjusting a gamma value of the background image based on the measured average brightness value. The device 100 may measure the average brightness value of the background image and adjust the gamma value of the background image by, for example, controlling the OS of the device 100.

FIG. 8 is a flowchart of a method by which a device changes a background image, an icon image, and a widget image on a screen according to a power saving level set by a user according to an embodiment of the present disclosure.

Referring to FIG. 8, in operation S800, the device 100 receives a user input for setting the power saving level. The device 100 may display a user interface for setting the power saving level, on the screen of the device 100 and may receive a user input through the displayed user interface. For example, the user interface for setting the power saving level may be included in a setting screen of the device 100. In another example, the user interface for setting the power saving level may be included in a certain widget. The power saving level may include, for example, the first power saving level, the second power saving level, and the third power saving level but is not limited thereto.

In operation S810, the device 100 determines the power saving level based on the user input. The device 100 may determine the power saving level according to the user input received in operation S800.

In operation S820, the device 100 changes the background image, the icon image, and the widget image according to the determined power saving level. The device 100 may change the background image, the icon image, and the widget image by using software installed in the device 100 and may selectively display the changed background image, the changed icon image, and the changed widget image on the screen of the device 100.

For example, when the power saving level of the device 100 is the first power saving level, the device 100 may change a brightness of the background image and brightness of the widget image. In addition, the device 100 may display the changed background image and the changed widget image on the screen.

In another example, when the power saving level of the device 100 is the second power saving level, the device 100 may change the icon image and the widget image to images of the line-drawing style and display the changed icon image and the changed widget image on the screen.

In another example, when the power saving level of the device 100 is the third power saving level, the device 100 may change the background image to a black image and change a color of the icon image changed to the line-drawing style and a color of the widget image changed to the line-drawing style.

In this case, the device 100 may change, to a low-power color, the color of the icon image changed to the line-drawing style and the color of the widget image changed to the line-drawing style.

It has been described with reference to FIGS. 7 to 8 that the brightness of the background image and the widget image is discontinuously changed according to the power saving level. However, one or more embodiments of the present disclosure are not limited thereto. The brightness of the background image and the widget image may be continuously changed according to the power saving level. In this case, the power saving level may have continuous values. In addition, when the power saving level of the device 100 is gradually lowered, the device 100 may change the brightness of the background image and the widget image to be gradually dark.

In addition, the device 100 may change and display a value indicating a remaining capacity of the battery of the device when the power saving level is changed. For example, while the device 100 is displaying the remaining capacity of the battery as “40%”, the device 100 may operate in a low-power environment since the power saving level of the device 100 is changed. In this case, the device 100 may display the remaining capacity of the battery as “50%” based on the changed power saving level. In another example, while the device 100 is displaying the remaining capacity of the battery as “one hour”, the device 100 may operate in a low-power environment since the power saving level of the device 100 is changed. In this case, the device 100 may display the remaining capacity of the battery as “one hour and 20 minutes” based on the changed power saving level. A unit of a remaining capacity of the battery may include, for example, % and a time but is not limited thereto.

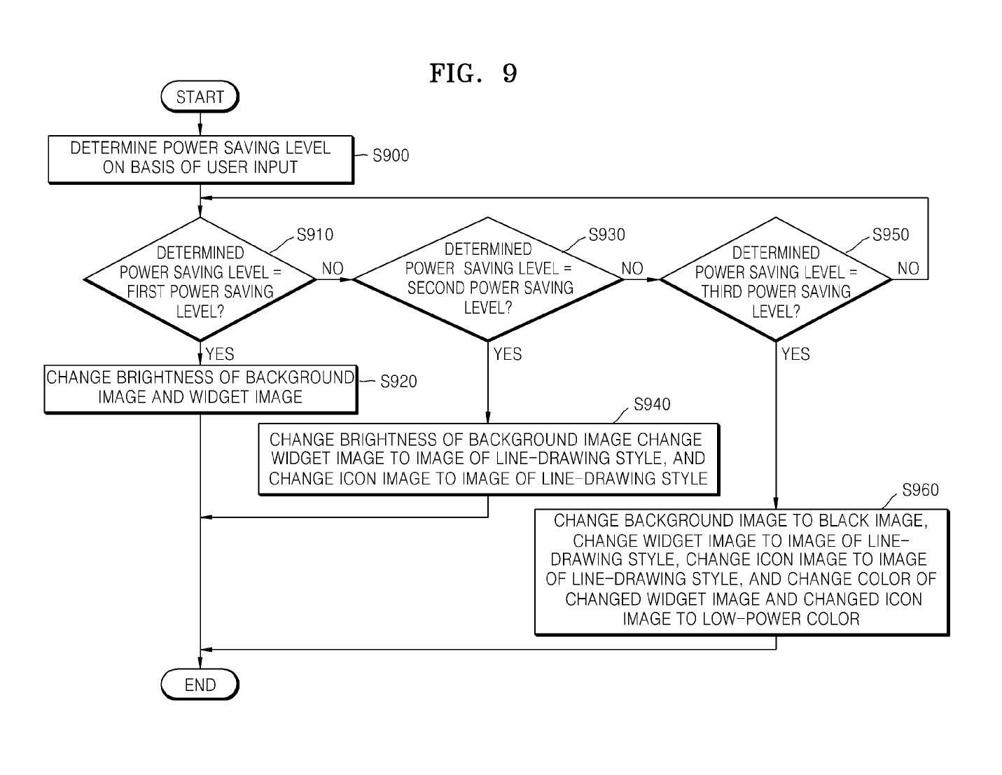

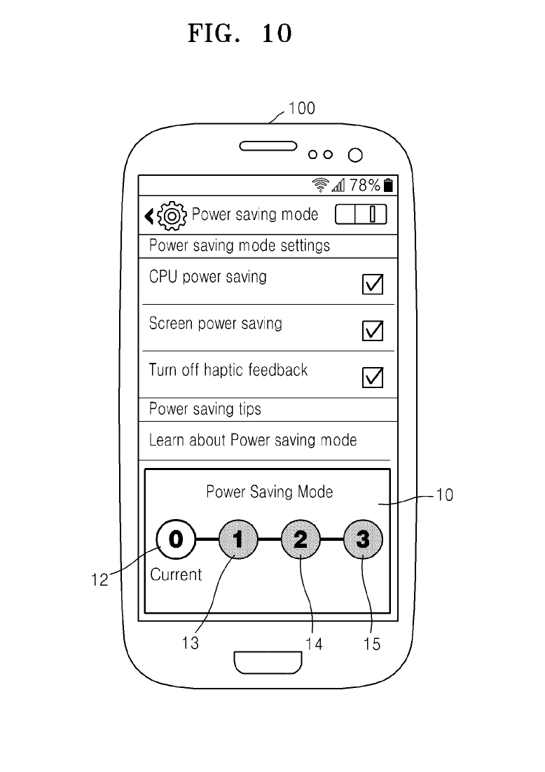

FIG. 9 is a flowchart of a method by which a device changes a background image, an icon image, and a widget image on a screen according to a power saving level set by a user according to an embodiment of the present disclosure.

Referring to FIG. 9, in operation S900, the device 100 determines the power saving level based on a user input. The device 100 may determine the power saving level according to a user input received through a user interface for setting the power saving level.

In operation S910, the device 100 determines whether the determined power saving level is the first power saving level.

If the power saving level of the device 100 is the first power saving level as the determination result in operation S910, the device 100 changes brightness of the background image and the widget image in operation S920. The device 100 may change the brightness of the background image and the widget image by using software installed in the device 100. For example, the device 100 may change the brightness of the background image and the widget image by applying an image filter to the background image and the widget image. The device 100 may display the background image and the widget image of which the brightness has been changed, on the screen of the device 100.

In addition, in operation S920, the device 100 may maintain a graphic style of the background image, a graphic style of the widget image, an image effect applied to the background image, an image effect applied to the widget image, and a font style of widget image without change. In addition, in operation S920, the device 100 may not change the icon image. The device 100 may maintain a graphic style of the icon image, an image effect applied to the icon image, and a font style of the icon image without change.

If the power saving level of the device 100 is not the first power saving level as the determination result in operation S910, the device 100 determines whether the determined power saving level is the second power saving level in operation S930.

If the power saving level of the device 100 is the second power saving level as the determination result in operation S930, the device 100 changes the brightness of the background image, changes the widget image to an image of the line-drawing style, and changes the icon image to an image of the line-drawing style in operation S940. The device 100 may change the brightness of the background image and change the widget image and the icon image to images of the line-drawing style by using software installed in the device 100. The widget image of the line-drawing style and the icon image of the line-drawing style may exhibit a white color but are not limited thereto. The widget image of the line-drawing style and the icon image of the line-drawing style may be previously generated and stored in a memory of the device 100.

In addition, in operation S940, the device 100 may remove the image effect applied to the background image, the image effect applied to the widget image, and the image effect applied to the icon image. In addition, in operation S940, the device 100 may maintain the font style of the icon image and the font style of the widget image without change. However, one or more embodiments of the present disclosure are not limited thereto.

If the power saving level of the device 100 is not the second power saving level as the determination result in operation S930, the device 100 determines whether the determined power saving level is the third power saving level in operation S950.

If the power saving level of the device 100 is the third power saving level as the determination result in operation S950, the device 100 changes the background image to a black image, changes the widget image and the icon image to images of the line-drawing style, and changes a color of the widget image of the line-drawing style and the icon image of the line-drawing style to a low-power color in operation S960. The device 100 may display the black image, the widget image of the line-drawing style of which the color has been changed, and the icon image of the line-drawing style of which the color has been changed, on the screen of the device 100.

The low-power color may be set based on experimental data regarding colors displayed on the screen of the device 100 and power consumption of the device 100. For example, in order to reduce power consumption of an OLED display, the low-power color may be set to a green-based color. The low-power color may be set differently according to a type of a display forming the screen of the device 100 and device characteristics of the device 100.

In addition, in operation S960, the device 100 may enable light-emitting elements corresponding to the icon image changed to the line-drawing style among light-emitting elements for displaying images on the screen of the device 100. In addition, the device 100 may disable light-emitting elements (the other light-emitting elements which do not correspond to the icon image changed to the line-drawing style) corresponding to the black image. However, one or more embodiments of the present disclosure are not limited thereto.

In addition, in operation S960, the device 100 may change the font style of the icon image and the font style of the widget image. For example, the device 100 may make a thickness of a text in the icon image and a thickness of a text in the widget image thin. However, one or more embodiments of the present disclosure are not limited thereto.

In the specification, the first power saving level may correspond to the first threshold range, the second power saving level may correspond to the second threshold range, and the third power saving level may correspond to the third threshold range. However, one or more embodiments of the present disclosure are not limited thereto.

FIG. 10 illustrates a power saving level setting menu displayed on a setting screen of a device according to an embodiment of the present disclosure.

Referring to FIG. 10, a power saving level setting menu 10 may be displayed on a setting screen for setting power saving of the device 100. The power saving level setting menu 10 may include a plurality of buttons 12, 13, 14, and 15 respectively corresponding to a plurality of power saving levels. For example, when a user touches one of the plurality of buttons 12, 13, 14, and 15, the device 100 may change a background image, a widget image, and an icon image according to a power saving level corresponding to the touched button.

In another example, when the user touches the button 12 and drags and drops a touched finger along a line connecting the plurality of buttons 12, 13, 14, and 15, the device 100 may change the background image, the widget image, and the icon image according to a power saving level corresponding to a button close to a location where the touched finger has dropped. In another example, the user may drag a touched finger to adjust brightness of a backlight of the device 100 in a hardware manner. However, one or more embodiments of the present disclosure are not limited thereto.

The power saving level setting menu 10 may have a bar shape. In this case, when the user touches the bar with a finger and moves the touched finger along the bar, the device 100 may continuously change a brightness of the background image and the widget image. In this case, the device 100 may adjust the brightness of the background image by measuring an average brightness value of the background image and adjusting a gamma value of the background image based on the measured average brightness value.

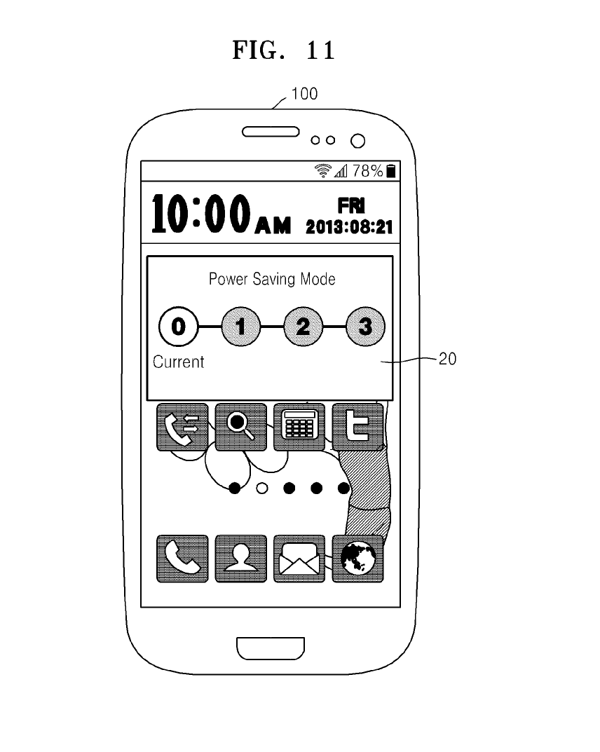

FIG. 11 illustrates a power saving level setting menu displayed in a widget format on a screen of a device according to an embodiment of the present disclosure.

Referring to FIG. 11, a power saving level setting widget 20 may be displayed on a home screen of the device 100. The power saving level setting widget 20 may include a plurality of buttons respectively corresponding to a plurality of power saving levels. For example, when a user touches one of the plurality of buttons, the device 100 may change a background image, a widget image, and an icon image according to a power saving level corresponding to the touched button.

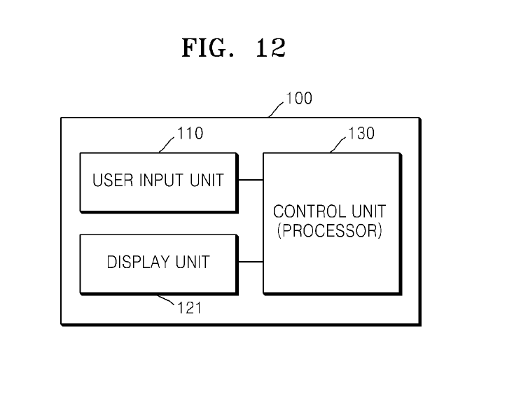

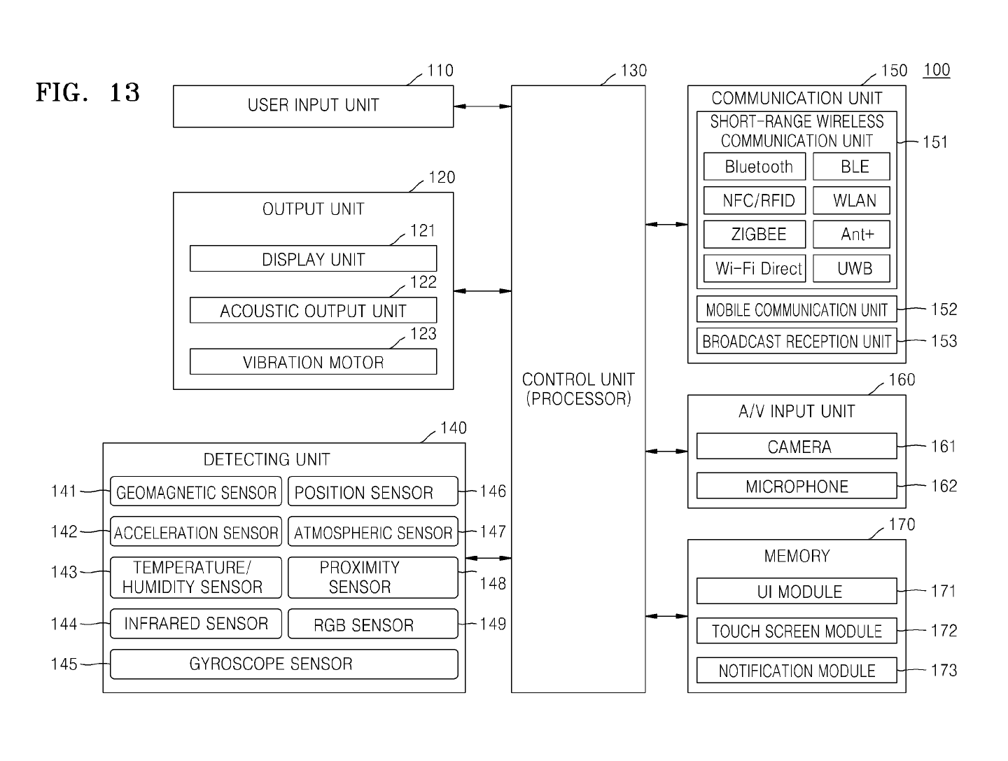

FIGS. 12 and 13 are block diagrams for describing a configuration of a device according to an embodiment of the present disclosure.

Referring to FIG. 12, the device 100 according to an embodiment of the present disclosure may include a user input unit 110, a display unit 121, and a control unit 130. However, all the shown components are not necessarily requisite components. The device may include more or less components than the shown components.

Referring to FIG. 13, the device 100 according to an embodiment of the present disclosure may further include a detecting unit 140, a communication unit 150, an Audio/Video (A/V) input unit, and a memory 170 besides the user input unit 110, the display unit 121, and the control unit 130. In addition, the display unit 121 may be included in an output unit 120.

The components described above will now be described.

The user input unit 110 indicates a means through which a user inputs data for controlling the device 100. For example, the user input unit 110 may include a keypad, a dome switch, a touch pad (a capacitive overlay method, a resistive overlay method, an infrared beam method, a surface acoustic wave method, an integral strain gauge method, a piezoelectric method, or the like), a jog wheel, a jog switch, and the like but is not limited thereto.

The user input unit 110 may receive a user input. The user input unit 110 may receive a user input for setting a power saving level.

The output unit 120 outputs an audio signal, a video signal, or a vibration signal and may include the display unit 121, an acoustic output unit 122, a vibration motor 123, and the like.

The display unit 121 displays information processed by the device 100 under control of the control unit 130 to be described below. The display unit 121 may display a background image, a widget image, and an icon image. In addition, the display unit 121 may display a background image, a widget image, and an icon image which have been changed by the control unit 130. Under control of the control unit 130, the display unit 121 may display a changed background image, a changed widget image, and a changed icon image according to a battery level of the device 100 or a power saving level set by the user.

When the display unit 121 and the touch pad are formed in a layer structure as a touch screen, the display unit 121 may be used as an input device, as well as an output device. The display unit 121 may include at least one selected from the group consisting of a Liquid Crystal Display (LCD), a Thin Film Transistor-Liquid Crystal Display (TFT-LCD), an OLED, a flexible display, a three-dimensional (3D) display, an electrophoretic display, and the like. In addition, according to an implementation form of the device 100, the device 100 may two or more display units 121. In this case, the two or more display units 121 may be arranged to face each other by using a hinge.

The acoustic output unit 122 outputs audio data received from the communication unit 150 or stored in the memory 170. In addition, the acoustic output unit 122 outputs acoustic signals related to functions (e.g., a call signal reception sound, a message reception sound, and a notification sound) performed by the device 100. The acoustic output unit 122 may include a speaker, a buzzer, and the like.

The vibration motor 123 may output a vibration signal. For example, the vibration motor 123 may output a vibration signal corresponding to an output of audio data or video data (e.g., a call signal reception sound, a message reception sound, or the like). In addition, the vibration motor 123 may output a vibration signal when a touch is input on the touch screen.

The control unit 130 commonly controls the general operation of the device 100. For example, the control unit 130 may generally control the user input unit 110, the output unit 120, the detecting unit 140, the communication unit 150, the A/V input unit 160, and the like by executing programs stored in the memory 170. In addition, the control unit 130 may control the user input unit 110, the output unit 120, the detecting unit 140, the communication unit 150, and the A/V input unit 160 so that the device 100 changes the background image, the widget image, and the icon image according to a battery level or a power saving level set by the user.

More specifically, the control unit 130 determines a battery level of the device 100. For example, the device 100 may measure a remaining capacity of a battery of the device 100 as a percentage (%) of a total capacity of the battery. In addition, the control unit 130 determines whether the battery level is within which one of a plurality of threshold ranges.

If the battery level of the device 100 is within the first threshold range, the control unit 130 may change a brightness of the background image and the widget image by using software installed in the device 100. For example, the control unit 130 may change the brightness of the background image and the widget image by applying an image filter to the background image and the widget image. The control unit 130 may display the background image and the widget image of which the brightness has been changed. In addition, the control unit 130 may maintain a graphic style of the background image, a graphic style of the widget image, an image effect applied to the background image, an image effect applied to the widget image, and a font style of widget image without change. In addition, the control unit 130 may not change the icon image. The control unit 130 may maintain a graphic style of the icon image, an image effect applied to the icon image, and a font style of the icon image without change.

In addition, if the battery level of the device 100 is within the second threshold range, the control unit 130 changes the widget image to an image of the line-drawing style and changes the icon image to an image of the line-drawing style. The control unit 130 may change the widget image and the icon image to images of the line-drawing style by using software installed in the device 100. The control unit 130 may change the widget image and the icon image to images of the line-drawing style by using, for example, an edge detection technique. The control unit 130 may display the widget image of the line-drawing style and the icon image of the line-drawing style. The widget image of the line-drawing style and the icon image of the line-drawing style may exhibit a white color but are not limited thereto. The widget image of the line-drawing style and the icon image of the line-drawing style may be previously generated and stored in the memory 170. In addition, the control unit 130 may remove the image effect applied to the background image, the image effect applied to the widget image, and the image effect applied to the icon image. In addition, the control unit 130 may maintain the font style of the icon image and the font style of the widget image without change. However, one or more embodiments of the present disclosure are not limited thereto.

In addition, if the battery level of the device 100 is within the third threshold range, the control unit 130 changes the background image to a black image and changes a color of the widget image of the line-drawing style and the icon image of the line-drawing style to a low-power color. The control unit 130 may display the black image, the widget image of the line-drawing style of which the color has been changed, and the icon image of the line-drawing style of which the color has been changed. The low-power color may be set based on experimental data regarding colors displayed on the screen of the device 100 and power consumption of the device 100. For example, in order to reduce power consumption of an OLED display, the low-power color may be set to a green-based color. The low-power color may be set differently according to a type of a display forming the screen of the device 100 and device characteristics of the device 100. In addition, the control unit 130 may enable light-emitting elements corresponding to the icon image changed to the line-drawing style among light-emitting elements included in the device 100. In addition, the control unit 130 may disable light-emitting elements (the other light-emitting elements which do not correspond to the icon image changed to the line-drawing style) corresponding to the black image. However, one or more embodiments of the present disclosure are not limited thereto. In addition, the control unit 130 may change the font style of the icon image and the font style of the widget image. For example, the control unit 130 may make a thickness of a text in the icon image and a thickness of a text in the widget image thin. However, one or more embodiments of the present disclosure are not limited thereto.

The control unit 130 may change the background image, the widget image, and the icon image according to a power saving level set by the user.

More specifically, the control unit 130 determines the power saving level based on a user input. The control unit 130 may display a user interface for setting the power saving level and determine the power saving level according to a user input received through the user interface. In addition, the control unit 130 may determine whether the determined power saving level is which one of a plurality of power saving levels.

If the power saving level of the device 100 is the first power saving level, the control unit 130 changes brightness of the background image and brightness of the widget image. In this case, the control unit 130 may maintain a graphic style of the background image, a graphic style of the widget image, an image effect applied to the background image, an image effect applied to the widget image, and a font style of widget image without change. In addition, the control unit 130 may not change the icon image. The control unit 130 may maintain a graphic style of the icon image, an image effect applied to the icon image, and a font style of the icon image without change.

If the power saving level of the device 100 is the second power saving level, the control unit 130 changes the brightness of the background image, changes the widget image to an image of the line-drawing style, and changes the icon image to an image of the line-drawing style. The widget image of the line-drawing style and the icon image of the line-drawing style may exhibit a white color but are not limited thereto. In this case, the control unit 130 may remove the image effect applied to the background image, the image effect applied to the widget image, and the image effect applied to the icon image. In addition, the control unit 130 may maintain the font style of the icon image and the font style of the widget image without change. However, one or more embodiments of the present disclosure are not limited thereto.

If the power saving level of the device 100 is the third power saving level, the control unit 130 changes the background image to a black image, changes the widget image and the icon image to images of the line-drawing style, and changes a color of the widget image of the line-drawing style and the icon image of the line-drawing style to a low-power color. The control unit 130 may display the black image, the widget image of the line-drawing style of which the color has been changed, and the icon image of the line-drawing style of which the color has been changed. In addition, the control unit 130 may enable light-emitting elements corresponding to the icon image changed to the line-drawing style among light-emitting elements included in the display unit 121 of the device 100. In addition, the control unit 130 may disable light-emitting elements (the other light-emitting elements which do not correspond to the icon image changed to the line-drawing style) corresponding to the black image. However, one or more embodiments of the present disclosure are not limited thereto. In addition, the control unit 130 may change the font style of the icon image and the font style of the widget image. For example, the control unit 130 may make a thickness of a text in the icon image and a thickness of a text in the widget image thin. However, one or more embodiments of the present disclosure are not limited thereto.

The detecting unit 140 may include at least one selected from the group consisting of a geomagnetic sensor 141, an acceleration sensor 142, a temperature/humidity sensor 143, an infrared sensor 144, a gyroscope sensor 145, a position sensor (e.g., GPS) 146, an atmospheric sensor 147, a proximity sensor 148, and an RGB sensor (illuminance sensor) 149 but is not limited thereto. Since functions of the respective sensors may be intuitively inferred by those of ordinary skill in the art from names thereof, a description thereof is omitted.

The communication unit 150 may include one or more components for allowing the device 100 to communicate with an external device (not shown) or a server (not shown). For example, the communication unit 150 may include a short-range wireless communication unit 151, a mobile communication unit 152, and a broadcast reception unit 153.

The short-range wireless communication unit 151 may include a Bluetooth communication unit, a Bluetooth Low Energy (BLE) communication unit, a near field communication unit, a Wireless Local Area Network (WLAN: Wi-Fi) communication unit, a Zigbee communication unit, an Infrared Data Association (IrDA) communication unit, a Wi-Fi Direct (WFD) communication unit, an ultra wideband communication unit, an Ant+ communication unit, and the like, but is not limited thereto.

The mobile communication unit 152 transmits and receives a wireless signal to and from at least one selected from the group consisting of base stations, external terminals, and servers in a mobile communication network. The wireless signal may include a voice call signal, a video call signal, or various types of data according to text/multimedia message transmission and reception.

The broadcast reception unit 153 receives a broadcast signal and/or broadcast related information from the outside through a broadcast channel. The broadcast channel may include satellite channels and terrestrial channels. According to one or more embodiments of the present disclosure, the device 100 may not include the broadcast reception unit 153.

The communication unit 150 transmits and receives data to and from the external device 200 under control of the control unit 130.

The AN input unit 160 is used to input an audio signal or a video signal and may include a camera 161, a microphone 162, and the like. The camera 161 may acquire an image frame of a still image or a video through an image sensor in a video call mode or a capturing mode. An image captured by the image sensor may be processed by the control unit 130 or a separate image processing unit (not shown).

The image frame processed by the camera 161 may be stored in the memory 170 or transmitted to the outside through the communication unit 150. The camera 161 may be two or more in number according to a configuration specification of the device 100.

The microphone 162 receives an acoustic signal from the outside and processes the received acoustic signal to electrical voice data. For example, the microphone 162 may receive an acoustic signal from an external device or a speaker. The microphone 162 may use various noise cancellation algorithms for cancelling noise generated during an input of an external acoustic signal.

The memory 170 may store programs for processing and controlling of the control unit 130 and input/output data.

The memory 170 may include at least one type of storage medium selected from the group consisting of a flash memory type memory, a hard disk type memory, a multimedia card micro type memory, a card type memory (e.g., a Secure Digital (SD) memory, an eXtreme Digital (XD) memory, or the like), a Random Access Memory (RAM), a Static RAM (SRAM), a Read-Only Memory (ROM), a Programmable ROM (PROM), an Electrically Erasable PROM (EEPROM), a magnetic memory, a magnetic disk, an optical disc, and the like. The device 100 may operate a web storage or a cloud server for performing a storage function of the memory 170 in the Internet.

The programs stored in the memory 170 may be classified into a plurality of modules according to functions thereof, for example, a User Interface (UI) module 171, a touch screen module 172, a notification module 173, and the like.

The UI module 171 may provide a specified UI, GUI, or the like cooperated with the device 100 for each application. The touch screen module 172 may detect a touch gesture of the user on the touch screen and deliver information about the touch gesture to the control unit 130. The touch screen module 172 according to an embodiment of the present disclosure may recognize and analyze a touch code. The touch screen module 172 may be configured with separate hardware including a controller.

In order to detect a touch or a proximity touch on the touch screen, various sensors may be provided inside or near the touch screen. One of the various sensors for detecting a touch on the touch screen is, for example, a tactile sensor. The tactile sensor is a sensor for detecting a contact of a certain object as well as or more than a human being feels. The tactile sensor may detect various pieces of information, such as roughness of a contact surface, solidity of a contact object, a temperature of a contact point, and the like.

The notification module 173 may generate a signal for notifying the occurrence of an event in the device 100. Examples of the event occurring in the device 100 are call signal reception, message reception, key signal input, schedule notification, and the like. The notification module 173 may output a notification signal in a video signal format through the display unit 121, output a notification signal in an audio signal format through the acoustic output unit 122, or output a notification signal in a vibration signal format through the vibration motor 123.

One embodiment of the present disclosure may be implemented in a form of a recording medium including instructions executable by a computer, such as program modules executed by a computer. A computer-readable medium may be an arbitrary available medium which is accessible by a computer and includes volatile and nonvolatile media and detachable and non-detachable media. In addition, the computer-readable medium may include a computer storage medium and a communication medium. The computer storage medium includes volatile and nonvolatile and detachable and non-detachable media implemented by an arbitrary method or technique for storing information, such as computer-readable instructions, data structures, program modules or other data. The communication medium typically includes computer-readable instructions, data structures, program modules, other data of a data signal modulated, such as a carrier, or other transmission mechanisms and includes an arbitrary information transfer medium.

In addition, other embodiments of the present disclosure can also be implemented through computer-readable code/instructions in/on a medium, e.g., a computer-readable medium, to control at least one processing element to implement any above described embodiment. The medium can correspond to any medium/media permitting the storage and/or transmission of the computer-readable code.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

It should be understood that the embodiments described therein should be considered in a descriptive sense and not for purposes of limitation. Descriptions of features or aspects within each embodiment should typically be considered as available for other similar features or aspects in other embodiments.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method by which a device processes images displayed on a screen, the method comprising:
determining a battery level of the device;
comparing the battery level with a plurality of set threshold ranges; and
changing a background image and an icon image displayed on the screen of the device based on a comparison result.

2. The method of claim 1, wherein the changing of the background image and the icon image comprises changing a brightness of the background image and displaying the changed background image on the screen, when the battery level is less than a first threshold value and greater than a second threshold value.

3. The method of claim 2, wherein the changing of the background image and the icon image comprises changing the icon image to an image of a line-drawing style and displaying the changed icon image on the screen, when the battery level is less than the second threshold value and greater than a third threshold value.

4. The method of claim 3, wherein the changing of the background image and the icon image comprises changing the background image to a black image and changing a color of the icon image changed to the line-drawing style, when the battery level is less than the third threshold value.

5. The method of claim 4, wherein among light-emitting elements for displaying images on the screen of the device, light-emitting elements corresponding to the icon image changed to the line-drawing style are enabled, and light-emitting elements corresponding to the black image are disabled.

6. The method of claim 4, wherein the color of the icon image changed to the line-drawing style is changed to a low-power color.

7. The method of claim 1, further comprising changing a widget image displayed on the screen of the device.

8. The method of claim 7, wherein the changing of the widget image comprises changing a brightness of the widget image and displaying the changed widget image on the screen, when the battery level is less than the first threshold value and greater than the second threshold value.

9. The method of claim 8, wherein the changing of the widget image comprises changing the widget image to an image of a line-drawing style and displaying the changed widget image on the screen, when the battery level is less than the second threshold value and greater than the third threshold value.

10. The method of claim 9, wherein the changing of the widget image comprises changing a text color of the widget image changed to the line-drawing style when the battery level is less than the third threshold value.

11. The method of claim 2, wherein an average brightness value of the background image is measured, and a gamma value of the background image is adjusted based on the measured average brightness value.

12. The method of claim 2, wherein the brightness of the background image is continuously changed according to the battery level.

13. The method of claim 1, wherein the background image is displayed on the screen of the device through a first layer, and wherein the icon image is displayed on the screen of the device through a second layer.

14. The method of claim 1, wherein the background image comprises an image displayed on a home screen of the device, and wherein the icon image comprises icons for executing applications installed in the device.

15. A device for processing images displayed on a screen, the device comprising:
a display unit configured to display a background image and an icon image; and
a control unit configured to determine a battery level of the device, to compare the determined battery level with a plurality of set threshold ranges, and to change the displayed background image and icon image based on a comparison result.

16. The device of claim 15, wherein the control unit is further configured to change a brightness of the background image when the battery level is less than a first threshold value and greater than a second threshold value, and
wherein the display unit is further configured to display the changed background image.

17. The device of claim 16, wherein the control unit is further configured to change the icon image to an image of a line-drawing style when the battery level is less than the second threshold value and greater than a third threshold value, and
wherein the display unit is further configured to display the changed icon image.

18. The device of claim 17, wherein the control unit is further configured to change the background image to a black image and to change a color of the icon image changed to the line-drawing style, when the battery level is less than the third threshold value.

19. The device of claim 18, wherein the control unit is further configured to enable light-emitting elements corresponding to the icon image changed to the line-drawing style and to disable light-emitting elements corresponding to the black image, among light-emitting elements included in the display unit.

20. The device of claim 18, wherein the color of the icon image changed to the line-drawing style is changed to a low-power color.

21. The device of claim 15, wherein the display unit is further configured to display a widget image, and
wherein the control unit is further configured to change the displayed widget image based on the comparison result.

22. The device of claim 21, wherein the control unit is further configured to change a brightness of the widget image when the battery level is less than the first threshold value and greater than the second threshold value, and
wherein the display unit is further configured to display the changed widget image on the screen.

23. The device of claim 22, wherein the control unit is further configured to change the widget image to an image of a line-drawing style when the battery level is less than the second threshold value and greater than the third threshold value, and
wherein the display unit is further configured to display the changed widget image on the screen.

24. The device of claim 23, wherein the control unit is further configured to change a text color of the widget image changed to the line-drawing style when the battery level is less than the third threshold value.

25. The device of claim 16, wherein the control unit is further configured to measure an average brightness value of the background image and to adjust a gamma value of the background image based on the measured average brightness value.

26. The device of claim 16, wherein the brightness of the background image is continuously changed according to the battery level.

27. The device of claim 15, wherein the background image is displayed on the screen of the device through a first layer, and wherein the icon image is displayed on the screen of the device through a second layer.

28. The device of claim 15, wherein the background image comprises an image displayed on a home screen of the device, and wherein the icon image comprises icons for executing applications installed in the device.

29. A non-transitory computer-readable storage medium having stored therein program instructions, which when executed by a computer, perform the method of claim 1.
